(19) United States
(12) Patent Application Publication
(10) Pub. No.: US 2004/0161554 A1
(43) Pub. Date: Aug. 19, 2004

(54) Ink-jet recording sheet and producing method of the same

(75) Inventors: Yoshihiko Suda, Tokyo (JP); Toshihiko Iwasaki, Tokyo (JP); Junji Ito, Tokyo (JP); Yukako Taka, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/774,476

(22) Filed: Feb. 10, 2004

(30) Foreign Application Priority Data
Feb. 13, 2003 (JP) JP2003-035003
Feb. 13, 2003 (JP) JP2003-035004

(51) Int. Cl. B41J 2/01

(52) U.S. Cl. 428/32.1

(57) ABSTRACT

An ink-jet recording sheet comprising a support having thereon an ink absorptive layer containing a multivalent metal compound which is coordinated with an amino acid.

### TECHNICAL FIELD

The present invention relates to an ink-jet recording sheet and an ink-jet recording sheet production method, and in more detail to an ink-jet recording sheet which exhibits excellent ink absorbability and surface glossiness, results in high image density as well as minimal bronzing, and exhibits improved color balance as well as improved bleeding resistance under high humidity, and minimizes quality degradation such as minute surface problems and cracking problems while maintaining stable quality over an extended period of time, and an ink-jet recording sheet production method which stably produces the same.

### BACKGROUND

In recent years, along with rapid technical innovations of ink-jet recording systems, print quality is approaching that of conventional silver salt photography. Print quality achieved by ink-jet recording depends mainly on printers, inks, and ink-jet recording sheets. Heretofore, technical innovation of printers and inks has made a major contribution to improve image quality. However, recently, importance of quality improvement of ink-jet recording sheets has been increasingly noted.

Heretofore, for the purpose of obtaining prints similar to conventional silver salt photographic prints employing ink-jet recording systems, various improvements have been made for ink-jet recording sheets.

Ink-jet recording sheets are divided mainly into those comprised of a support such as paper which is ink absorptive itself and those comprising a support having thereon an ink absorptive layer. The former is not capable of producing high quality prints since desired maximum density is occasionally not achieved due to direct penetration of ink into the support, or the support itself absorbs ink solvents to result in marked wrinkling (also called cockling) of images.

Contrary to this, ink-jet recording sheets comprising a non-ink absorptive support having thereon an ink absorptive layer result in none of the drawbacks described above and are capable of producing high quality ink-jet prints. Specifically, ink-jet recording sheets, which comprise a support prepared by covering both sides of a paper sheet with polyolefin resins such as polyethylene, so-called RC paper, having thereon an ink absorptive layer, have increasingly been employed since its cost is relatively low compared to plastic films and high quality prints approaching conventional silver salt photographic prints are prepared due to its profound-feeling, flexibility, flatness, and glossiness.

In ink-jet recording, water-soluble dyes are commonly used as a colorant. As a result, when ink-jet prints are stored under high humidity for an extended period of time after printing, or water droplets are allowed to adhere to the recorded surface, dyes tends to bleed. Therefore, the problem of insufficient water resistance has not yet been solved.

In order to overcome the aforesaid drawbacks, dye fixing substances are generally incorporated into the ink receptive layer. Listed as such ink fixing substances are inorganic pigments (such as minute alumina particles) with a cationic surface, as well as cationic polymers having a quaternary ammonium base in the molecule. In addition, techniques are proposed in which various multivalent metal compounds are used (refer, for example, to Patent Documents 1-4). Of these, zirconium compounds are proposed as ones which result in bleeding resistance in the same manner as aluminum compounds and magnesium compounds. On the other hand, a method (refer, for example, to Patent Document 5) is disclosed in which multivalent metal compounds are individually employed to enhance bleeding resistance. However, this method results in problems in which bronzing tends to occur. Further, problems occur in which color balance tends to degrade due to a large difference in mordanting force depending on the type of inks. Further, multivalent metal compounds are not always stable in an aqueous solution. Since the aforesaid multivalent metal ions exhibit properties to coagulate hydrophilic polymers having a negative charge, recently techniques are being sought to improve the method of their use.

On the other hand, heretofore, widely known as high quality ink-jet recording sheets are those in which a porous ink receptive layer is formed on a support, employing minute inorganic particles as well as hydrophilic polymers having a hydroxyl group.

For the purpose of enhancement of water resistance of these ink-jet-recording sheets, techniques are disclosed in which water-soluble metal compounds are incorporated into the ink absorptive layer (refer, for example, to Patent Document 6). However, when these water-soluble metal compounds are added to a liquid coating composition comprising minute inorganic particles as well as hydrophilic polymers having a hydroxyl group, the resulting liquid coating composition tends to gel and increase in viscosity. As a result, it has been difficult to stably produce high quality recording sheets using this technique.

Further, techniques are disclosed in which water-soluble metals are added utilizing an in-line process (refer, for example, to Patent Document 7). By employing the disclosed techniques, gelling and an increase in viscosity of liquid coating compositions are minimized. However, it is assumed that chemical reactions related to gelling still take place. Consequently, quality degradation such as the formation of minute surface problems as well as cracking results. In addition, when production is carried out over an extended period, the aforesaid problems are more pronounced and liquid coating compositions are allowed to firmly adhere to the wall surface of piping to result in occasional clogging.

On the other hand, techniques are disclosed in which, by maintaining the pH of the layer surface of ink-jet recording sheets at 3-5, ink absorbability is improved and bleeding under high humidity is minimized (refer, for example, to Patent Document 3). Further, techniques are disclosed in which by simultaneously employing acids at a pKa of at least 1.0 and salts of alkali metal, cracking as well as bleeding under high humidity is minimized (refer, for example, to Patent Document 4). However, a difference exists between the pH range in which the liquid coating composition comprising minute inorganic particles as well as hydrophilic polymers having a hydroxyl group are stable during its standing and the pH range in which the ink absorptive layer prepared by drying the aforesaid composition exhibits the desired ink absorbability. Accordingly, even though each of the aforesaid techniques is employed, it is not possible to satisfy these.

(Patent Document 1)

Japanese Patent Publication Open to Public Inspection (hereinafter referred to as JP-A) No. 10-258567 (claims)

(Patent Document 2)

JP-A No. 10-309862 (claims)

(Patent Document 3)

JP-A No. 2001-96897 (claims)

(Patent Document 4)

JP-A No. 2001-113819 (claims)

(Patent Document 5)

JP-A No. 2002-274013 (claims)

(Patent Document 6)

JP-A No. 2000-309157 (claims)

(Patent Document 7)

JP-A No. 2001-71628 (claims)

In view of the aforesaid problems, the present invention was achieved. A first objective is to provide an ink-jet recording sheet. which exhibits excellent ink absorbability and surface glossiness, results in high image density as well as minimal bronzing, and exhibits improved color balance as well as improved bleeding resistance under high humidity, and minimizes quality degradation such as minute surface problems and cracking problems, and can be produced while maintaining stable quality over an extended period of time.

A second objective is to provide an ink-jet recording sheet production method which stably produces the same.

### SUMMARY

The above-mentioned object of the present invention can be achieved by the following embodiments.

(1) An ink-jet recording sheet comprising a support having thereon an ink absorptive layer containing a multivalent metal compound which is coordinated with an amino acid.

(2) The ink-jet recording sheet of Item 1, wherein the ink absorptive layer further contains inorganic microparticles and a hydrophilic polymer and the ink absorptive layer is a porous layer.

(3) A method for preparing the ink-jet recording sheet of Item 2, comprising the steps of:

(a) mixing the multivalent metal compound and the amino acid to obtain a first composition;

(b) mixing inorganic microparticles and a hydrophilic polymer to obtain a second composition;

(c) mixing the first composition with the second composition to obtain a coating mixture;

(d) coating the coating mixture on the support to provide the ink absorptive layer; and

(e) drying the ink absorptive layer.

(4) The method for preparing the ink-jet recording sheet of Item 3, wherein the mixing of the first composition with the second composition of the step (c) is carried out in an in-line mixing system.

(5) The ink-jet recording sheet of any one of Items 1 and 2, wherein the multivalent metal compound is selected from the group consisting of zirconium compounds, aluminum compounds and magnesium compounds.

(6) The ink-jet recording sheet of Item 5, wherein the multivalent metal compound is a zirconium compound.

(7) The ink-jet recording sheet of any one of Items 1 and 2, wherein the support is non water absorptive.

(8) A method for preparing the ink-jet recording sheet of Item 2, wherein the ink absorptive layer is prepared comprising the steps of:

(a) mixing the multivalent metal compound, the amino acid, inorganic microparticles and a hydrophilic polymer having an hydroxyl group in the molecule to obtain a coating mixture;

(b) coating the coating mixture on the support to provide the ink absorptive layer; and

(c) drying the ink absorptive layer,

wherein a pH value of the coating mixture of the step (a) is smaller than a pH value of a surface of the dried ink absorptive layer by an amount of not less than 0.2.

(9) The method according to Item 8, wherein a volatile acid or a salt of the volatile acid is further mixed to the coating mixture of the step (a).

(10) The method according to Item 9, wherein the mixing step (a) is carried out in an in-line mixing system by mixing the following two compositions:

(i) a first composition containing the multivalent metal compound, the amino acid, and the volatile acid or the salt of the volatile acid; and

(ii) a second composition containing the inorganic microparticles and the hydrophilic polymer.

(11) The ink-jet recording sheet of any one of Items 1 and 2, wherein the amino acid is selected from the group consisting of α-monoamino acids, β-monoamino acids and γ-monoamino acids, each amino acid having carbon atoms of not more than 11 in the molecule.

(12) The method according to Item 8, wherein the coating mixture obtained by the step (a) has a pH value of not more than 5.0; and the dried ink absorptive layer has a surface pH value of not less than 4.8.

In view of the aforesaid problems, the inventors of the present invention conducted diligent investigations. As a result, it was discovered that an ink-jet recording sheet which comprised a support having thereon an ink absorptive layer incorporating multivalent metal compounds as well as amino acids or which comprised a support having thereon an ink absorptive layer incorporating multivalent metal compounds coordinated with amino acids exhibited excellent ink absorbability and surface glossiness, resulted in high image density as well as minimal bronzing, and exhibited improved color balance as well as improved bleeding resistance under high humidity. Further, it was discovered that an ink-jet recording sheet production method in which an ink absorptive layer was formed by applying, onto a support, a liquid coating composition prepared employing a solution or a dispersion prepared by mixing multivalent metal compounds and amino acids was one which realized stable production. Based on these discoveries, the present invention was achieved.

It was also discovered that it was possible to exhibit target effects of the present invention by employing, in addition to the aforesaid constitution, the following constitution. Multivalent metal compounds are those which comprise a zirconium atom, an aluminum atom, or a magnesium atom; the ink absorptive layer is a porous layer which comprises minute inorganic particles as well as hydrophilic binders; the support is a non-water absorptive support; or the solution or the dispersion prepared by mixing multivalent compounds and amino acids is added via in in-line immediately prior to coating.

In view of the aforesaid problems, the inventors of the present invention conducted diligent investigations. As a result, it was discovered that in an ink-jet recording sheet provided with an ink receptive layer comprising minute inorganic particles as well as hydrophilic polymers having a hydroxyl group, by incorporating volatile acids or salts thereof as well as water-soluble multivalent metal compounds into the ink receptive layer, incorporating volatile acids or salts thereof as well as water-soluble multivalent metal compounds into the ink receptive layer forming liquid composition, or incorporating water-soluble multivalent metal compounds into the ink receptive layer and setting the pH of the liquid coating composition at the value which is at least 0.2 lower than the surface pH of the ink receptive layer, it was possible to realize an ink-jet recording sheet which exhibited high ink absorbability, excellent bleeding resistance under high humidity and minimized quality degradation such as minute surface problems and cracking problems and can be produced while maintaining stable quality over an extended period of time. The present invention was thus achieved.

It was also discovered that the intended effects of the present invention were further exhibited, in addition to the aforesaid constitution, by employing vapor phase process silica, employing polyvinyl alcohol as a hydrophilic polymer, incorporating boric acid or its salts into the ink receptive layer, incorporating water-soluble multivalent metal compounds into the liquid coating composition employing an in-line process just prior to coating, employing compounds comprising a zirconium atom or an aluminum atom as a water-soluble multivalent compound, or further, preferably at least one compound selected from zirconyl acetate, zirconium oxychloride and basic aluminum chloride, and employing non-water absorptive supports as a support.

### DESCRIPTION OF THE PREFERRED EMBODIMENTS

The present invention will now be detailed.

The ink-jet recording sheet (hereinafter also simply referred to-as a recording sheet) of the present invention is characterized in that the aforesaid ink-jet recording sheet comprises a support having thereon an ink absorptive layer incorporating multivalent metal compounds as well as amino acids or comprises a support having thereon an ink absorptive layer incorporating multivalent metal compounds coordinated with amino acids.

Initially, multivalent metal compounds according to the present invention will be described. Listed as multivalent metal compounds according to the present invention may be metal compounds comprised of, for example, aluminum, calcium, magnesium, zinc, iron, strontium, barium, nickel, copper, scandium, gallium, indium, titanium, zirconium, tin, and lead. Further, these multivalent metal compounds may be multivalent metal salts. Of these, compounds comprised of magnesium, aluminum, zirconium, calcium, and zinc are preferred since they are colorless. It is more preferable that the multivalent metal compounds are those incorporating a zirconium atom, an aluminum atom, or a magnesium atom, and it is most preferable that the multivalent metal compounds are those incorporating a zirconium atom.

Compounds (however, excluding zirconium oxide as well as aluminum oxide) incorporating a zirconium atom, an aluminum atom, or a magnesium atom, which are usable in the present invention, may be water-soluble or water-insoluble. However, preferred are those which can uniformly be incorporated at the desired location of the ink absorptive layer.

Further, the compounds, usable in the present invention, which incorporate a zirconium atom, an aluminum atom, or a magnesium atom, may be any of the simple salts or double salts of inorganic acids or organic acids, organic metal compounds, or metal complexes. However, preferred are compounds which can be uniformly incorporated at the desired location of the ink absorptive layer.

Listed as specific examples of zirconium atom containing compounds are zirconium difluoride, zirconium trifluoride, zirconium tetrafluoride, hexafluorozirconate (such as, potassium salts), heptafluorozirconate (such as, sodium salts, potassium salts, and ammonium salts), octafluorozirconate (such as, lithium salts), zirconium fluoride oxide, zirconium dichloride, zirconium trichloride, zirconium tetrachloride, hexachlorozirconate (such as, sodium salts and potassium salts), zirconium oxychloride (zirconyl chloride), zirconium dibromide, zirconium tribromide, zirconium tetrabromide, zirconium bromide oxide, zirconium triiodide, zirconium tetraiodide, zirconium peroxide, zirconium hydroxide, zirconium sulfide, zirconium sulfate, zirconium p-toluenesulfonate, zirconyl sulfate, sodium zirconyl sulfate, acidic zirconyl sulfate trihydrate, potassium zirconium sulfate, zirconium selenate, zirconium nitrate, zirconyl nitrate, zirconium phosphate, zirconyl carbonate, ammonium zirconyl carbonate, zirconium acetate, zirconyl acetate, ammonium zirconyl acetate, zirconyl lactate, zirconyl citrate, zirconyl stearate, zirconyl phosphate, zirconium oxalate, zirconium isopropionate, zirconium butyrate, zirconium acetylacetonate, acetyl acetone zirconium butyrate, zirconium stearate butyrate, zirconium acetate, bis(acetylacetonato)dichlorozirconium, and tris(acetylacetonato)chlorozirconium.

Of these compounds, from the viewpoint of further providing significant bleeding prevention effects after printing, preferred are zirconyl carbonate, ammonium zirconyl carbonate, zirconyl acetate, zirconyl nitrate, zirconyl chloride, and zirconyl citrate.

Listed as specific examples of aluminum atom containing salts which are suitable for the present invention are aluminum fluoride, hexafluoroaluminate (such as, potassium salts), aluminum chloride, basic aluminum chloride (such as, polyaluminum chloride), tetrachloroaluminate (such as, sodium salts), aluminum bromide, tetrabromoaluminate (such as, potassium salts), aluminum iodide, aluminate (such as, sodium salts, potassium salts, and calcium salts), aluminum chlorate, aluminum perchlorate, aluminum thiocyanate, aluminum sulfate, basic aluminum sulfate, aluminum potassium sulfate (alum), aluminum ammonium sulfate (ammonium alum), aluminum sodium sulfate, aluminum phosphate, aluminum nitrate, aluminum hydrogenphosphate, aluminum carbonate, aluminum silicate polysulfate, aluminum formate, aluminum acetate, aluminum lactate, aluminum oxalate, aluminum isopropionate, aluminum butyrate, ethyl acetate aluminum diisopropionate, aluminum tris(acetylacetonate), aluminum tris(ethylacetoacetate), and aluminum monoacetylacetonatebis(ethylacetoacetonate).

Of these, preferred are aluminum chloride, basic aluminum chloride, aluminum sulfate, basic aluminum sulfate, and basic aluminum silicate sulfate. More preferred is basic aluminum chloride.

Specific examples of magnesium atom containing compounds usable in the present invention include magnesium fluoride, magnesium acetate, magnesium bromide, magnesium chloride, magnesium formate, magnesium nitrate, magnesium sulfate, magnesium thiocyanate, magnesium thiosulfate, magnesium sulfide, magnesium carbonate, and magnesium phosphate. Of these, preferred are magnesium chloride, magnesium sulfate, and magnesium nitrate.

Of these multivalent metal compounds including the aforesaid exemplified compounds incorporating a zirconium atom as preferred, exemplified compounds incorporating a aluminum atom as preferred, and exemplified compounds incorporating a magnesium atom as preferred, particularly preferred are zirconyl carbonate, ammonium zirconyl carbonate, zirconyl acetate, zirconyl nitrate, zirconium oxychloride, zirconyl lactate, zirconyl citrate, basic aluminum chloride, magnesium chloride, magnesium sulfate, and basic aluminum sulfate silicate. Of these, zirconium oxychloride, ammonium zirconyl carbonate, and zirconyl acetate are particularly preferred, and zirconium oxychloride is most preferred.

Amino acids according to the present invention will now be described.

Amino acids, as described in the present invention refer to compounds having an amino group as well as a carboxyl group in the same molecule and may be any of the α-, β- and γ-amino acids. Some amino acids form optical isomers. In the present invention, optical isomers make no difference in the resulting effects. Therefore, any isomer may be employed individually or in the racemic form.

In regard to the detailed explanation of the amino acids in accordance with the present invention, it is possible to refer to the description on pages 268-270 of Kagaku Daijiten 1 Shukusatsu Ban (Encyclopedia CHIMICA, Abridged Edition), Kyoutrtsu Shuppan, 1960.

Preferred as amino acids in accordance with the present invention are those represented by General Formula (1) described below.

General Formula (1)

H₂N—R—COOH

wherein R represents an optional substituent which has preferably at most 11 carbon atoms and more preferably at most 8 carbon atoms. Of these, particularly preferred is at least one type selected from α-monoaminocarboxylic acid, β-monoaminocarboxylic acid, and γ-monoaminocarboxylic acid, having at most 11 carbon. atoms.

Specifically listed as preferable amino acids may be aminocarboxylic acid, glycine, alanine, baline, α-aminobutyric acid, γ-aminobutyric acid, β-alanine, serine, ε-amino-n-caproic acid, leucine, norleucine, and phenylalanine.

When the ink-jet recording sheet of the present invention comprises a plurality of ink absorptive layers, multivalent metal compounds as well as amino acids may be incorporated into one layer or other layers. However, from the viewpoint of more effectively exhibiting the effects of the present invention, it is preferable to incorporate them into only one layer.

Addition methods of multivalent metal compounds and amino acids include one method in which they may be added to an ink absorptive layer liquid coating composition (if desired, minute inorganic particles as well as hydrophilic binders are incorporated) while mixed, and the other method in which after coating and drying an ink absorptive layer, they may be overcoated thereon. These methods may be combined. Multivalent metal compounds and amino acids may be added employing the same addition method or employing different addition methods. A preferable method is one in which after multivalent metal compounds as well as amino acids are added to an ink absorptive layer liquid coating composition, coating is carried out. Based on this method, it is possible to intentionally control to some extent the existing position of multivalent metal compounds and amino acids after formation of the ink absorptive layer.

When multivalent metal compounds as well as amino acids are added to an ink absorptive layer forming liquid coating composition, they may be dissolved in water, organic solvents, or solvent mixtures thereof and then added, or they may be dispersed into minute particles employing a method, such as a wet system powdering method such as a sand mill or an emulsification dispersion method, and then added. When they are added employing the overcoating method after forming the ink absorptive layer, it is preferable that they are completely dissolved in solvents and then added.

When any of these methods is employed, it is preferable that multivalent metal compounds and amino acids are previously mixed prior to coating. The major objective of the present invention is to utilize effects derived by the coexistence of multivalent metal compounds and amino acids. By allowing amino acids to coexist in a multivalent metal compound solution or dispersion, it is possible to increase stability of the multivalent metal compound solution or dispersion. In such a coexisting state, it is easily assumed that ligand substitution occurs to some extent and multivalent metal-amino acid complexes are formed, judging from the complex salt dissociation constant of amino acids. In the present invention, the use of multivalent metal-amino acid complexes is not an essential factor, but is included as one of the embodiments. In advance, multivalent metal ions and amino acids are allowed to react with each other under appropriate conditions to form multivalent metal-amino acid complexes, and may then be added to a liquid coating composition and coated, or may be overcoated onto an ink absorptive layer.

The most preferable embodiment of the coating method of the ink absorptive layer according to the present invention is that a solution or a dispersion which has been prepared by mixing multivalent metal compounds as well as amino acids is added via in-line just prior to coating of the ink absorptive layer liquid coating composition.

By utilizing the in-line addition of each of these additives, it is possible to minimize interaction with other components of the liquid coating composition during standing storage. As a result, it is possible to enhance the stability of the liquid coating compositions as well as to satisfactorily exhibit the target effects of each additive according to the present invention.

In the present invention, the in-line addition method of each of the aforesaid additives refers to a method in which in a coating apparatus, just prior to applying a liquid coating composition onto a support, for example, to a pipe which is used to supply an ink receptive layer liquid coating composition as a primary liquid coating compositing to a coater, a pipe which is used to convey each of the aforesaid solutions as a secondary liquid coating composition is connected so that they are mixed.

On the down-stream side from a position where in-line addition is carried out, it is preferable to arrange an in-line mixing apparatus. Particularly preferred as the in-line mixing apparatus are generally well known static mixers. Such static mixers are described in N. Harmby, M. F. Edwards, and A. W. Nienow, “Ekitai Kongo Gijutsu (Liquid Mixing Techniques)”, translated by Koji Takahashi (published by Nikkan Kogyo Shimbun, Ltd. 1989), which may be used as a reference. Preferably employed as specific examples are in-line mixers such as a static mixer, manufactured by Toray Engineering Co., a static mixer, manufactured by Kenics Co. (USA), a static mixing element Type SMV, manufactured by Sulger Co. (Switzerland), a Shimazaki pipe mixer, manufactured by Koritsu Kogyo Co., SWJ (Toray static type in-pipe mixer Hi-Mixer), and static mixer N10, manufactured by Noritake Co.

The ink-jet recording sheet (hereinafter also simply referred to as the recording sheet) is characterized in that the aforesaid material comprises a support having thereon an ink absorptive layer comprising minute inorganic particles as well as hydrophilic polymers having a hydroxyl group and said ink absorptive layer comprises volatile acids or salts thereof as well as water-soluble multivalent compounds.

In the present invention, by employing volatile acids or salts thereof in the ink absorptive layer, it is possible to allow the relationship between the pH of the ink receptive layer liquid coating composition and the surface pH of the resulting layer preferred conditions specified by the present invention.

Firstly, volatile acids or salts thereof will be described.

Volatile acids, as described in the present invention, refer to acids which readily vaporize together with water, undergo no decomposition at normal pressure and vaporize. “Readily vaporize”, as described herein, means that in the production process of ink-jet recording sheets, it is possible to significantly confirm volatility along with a decrease in the water content of the ink receptive layer after coating the liquid coating composition. In the coating and drying processes of ink-jet recording sheets, various temperatures are chosen depending on the desired characteristics such as employed components, and image quality. In the present invention, it is preferable to use volatile acids which exhibit volatility at temperatures in the range of 0-150° C. It is possible to determine the volatility of volatile acids, for example, by carrying out quantitative analysis of residual volatile acids in the materials.

Listed as specific examples of volatile acids usable in the present invention are hydrochloric acid, nitric acid, hydrofluoric acid, carbonic acid, and lower fatty acid such as acetic acid, having at most ten carbon atoms. Of these, in view of volatility, acidity, and handling properties, carbonic acid and acetic acid are preferred.

In the present invention, it is also preferable that volatile acids are employed in the form of salts with cationic compounds. Listed as specific example are salts with alkaline metal ions such as sodium ions, potassium ions, or lithium ions, salts with alkaline earth metal ions such as magnesium ions, calcium ions, or barium ions, salts with metal ions such as aluminum ions, zirconium ions, or zinc ions, salts with complex ions including these metal ions, salts with inorganic or organic ammonium ions such as triethanol ammonium ions, or pyridinium ions, and salts with other organic compounds having a cationic group, in addition to polymers.

In the present invention, it is preferable that after vaporization of volatile acids, the pH of the liquid coating composition or the surface pH of the ink receptive layer increases. Preferred as the aforesaid cationic compounds are those which exhibit such characteristics that volatility is lower than that of volatile acids and the basicity of cationic compounds is higher than the acidity of volatile acids. Listed as specific examples of preferable cationic compounds are sodium ions, potassium ions, and lithium ions. Further, they may be employed in various combinations depending on the volatility and acidity of employed volatile acids, as well as the temperature and humidity of the production process of applied recording sheets.

In the present invention, the pH of a liquid coating composition refers to the pH of the liquid coating composition which is actually applied onto a support. Further, when a plurality of liquid coating compositions is applied, the pH of the liquid coating compositions is defined as the pH of the liquid composition which is prepared by mixing all the liquid coating compositions. Accordingly, when any of the compounds are coated via in-line addition, in the present invention, the pH after such in-line addition is designated as the pH of the liquid coating composition.

In the present invention, it is characterized that in an ink absorptive layer comprising the minute inorganic particles described below, hydrophilic polymers having a hydroxyl group, and water-soluble multivalent metal compounds, the pH of the liquid coating composition is at least 0.2 lower than the surface pH of the ink absorptive layer. The pH of the liquid coating composition is preferably 0.2-2.0 lower than the surface pH of the ink absorptive layer, and more preferably, 0.5-1.5 lower than the surface pH of the ink absorptive layer.

The surface pH of the ink absorptive layer, as described in the present invention, can be determined employing the following method. Namely, based on the method described in J. TAPPI Paper and Pulp Test Method No. 49, 50 μl of distilled water is placed on the test layer and an electrode is brought into contact with the wet layer surface for 30 seconds and subsequently, the pH is measured.

In the present invention, listed as combinations of multivalent metal compounds and volatile acids or salts thereof, which are described above, are a combination of the multivalent metal compound and the volatile acid, a combination of the multivalent metal compound and the volatile acid salt, and a combination of the multivalent metal compound, the volatile acid, and the volatile acid salt.

Further, for the purpose of realizing each effect of the multivalent metal compound and the volatile acid by employing a single compound, an embodiment is preferred in which addition is carried out in the form of the salt and the complex of the volatile acid and the multivalent metal compound. From this viewpoint, of multivalent metal compounds including those which are exemplified above as preferred zirconium atom containing compounds, those which are exemplified above as preferred aluminum atom containing compounds and those which are exemplified above as preferred magnesium atom containing compounds, listed as particularly preferred compounds may be zirconyl acetate, zirconium oxychloride and basic aluminum chloride.

Fine inorganic particles of this invention will be described. Fine inorganic particles are also referred to as inorganic microparticles.

As fine inorganic particles, various solid fine particles commonly known in the ink-jet recording sheet art may be employed.

Cited as examples of the fine inorganic particles may be white inorganic pigments such as light precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic non-crystalline silica, colloidal silica, alumina, colloidal alumina, pseudo boehmite, aluminum hydroxide, lithopone, zeolite, and magnesium hydroxide.

The foregoing fine particles may be employed in a state such that primary particles are uniformly dispersed in binders without any modification, or in a state such that secondary coagulated particles are formed which are dispersed into the binders. However, the latter is preferred from the viewpoint of achieving high ink absorbability.

The shape of the foregoing fine inorganic particles is not specifically limited which may be spherical, cylindrical, acicular, tabular, or beaded form.

The average particle diameter of the foregoing fine inorganic particles is preferably 3 to 200 nm.

In cases when the average particle diameter is 200 nm or less, high glossiness of the recording sheet can be achieved, and further, sharp images can be obtained without lowered maximum density by diffused reflection at the surface.

Composite particles comprised of fine inorganic particles and a small amount of organic materials (which may be either lower molecular weight compounds or polymers) are basically designated as the fine inorganic particles according to the present invention. Even in this case, the diameter of the highest order particles observed in the dried layer is determined as that of the fine inorganic particles.

The ratio of organic materials/fine inorganic particles in the foregoing composite particles comprised of fine inorganic particles and a small amount of organic materials is generally from 1/100-1/4.

Preferred as the fine inorganic particles according to the present invention are those which are less expensive to produce, have a low refractive index from the viewpoint of being capable of high reflection density, such as various kinds of silica. Of these, silica synthesized employing a gas phase method is more preferred.

Further, it is possible to employ cation surface-treated silica, synthesized by employing a gas phase method, cation surface-treated colloidal silica, alumina, colloidal alumina, and pseudo boehmite.

The added amount of fine inorganic particles, employed in the porous layer, depends largely on the desired ink absorption capacity, the void ratio of the void layer, the kinds of fine inorganic particles, and the kinds of water soluble binders, but is generally from 3-30 g per m² of the recording sheet, and is preferably from 5-25 g/m². The ratio of fine inorganic particles to a water soluble binder, employed in the ink absorbing layer, is generally from 2:1-20:1, and is specifically preferably from 3:1-10:1.

As the added amount of the fine inorganic particles increases, the ink absorption capacity also increases, while curling and cracking tend to deteriorate. Accordingly, a method, in which the ink absorption capacity is increased by controlling the void ratio, is more preferred. The void ratio is preferably 40-75%. It is possible to control the void ratio utilizing the selected inorganic fine particles, the kinds of binders, or the mixing ratio thereof, or the amount of other additives.

The void ratio, as described herein, is the ratio of the total volume of voids to the volume of the void layer, and can be calculated utilizing the total volume of the layer constituting materials and the thickness of the layer. Further, the total volume of the voids is easily determined through the saturated transition amount and the absorbed water amount utilizing Bristow's Measurement.

Next, a hydrophilic polymer having a hydroxy group used in ink-jet recording sheet of this invention will be described.

The term “hydrophilic” means not only soluble to water but also soluble to a mixed solvent of water and water-miscible organic solvents such as methanol, isopropyl alcohol and acetone. In this case, the amount of water-miscible organic solvents is generally 50 weight % or less to the total amount of solvents.

Further, a hydrophilic binder means a binder which can be dissolved at usually 1 weight % or more into the foregoing solvents at room temperature, and preferably dissolved at 3 weight % or more.

Further, a hydrophilic binder means a binder which can be dissolved at usually 1 weight % or more into the foregoing solvents at room temperature, and preferably dissolved at 3 weight % or more.

Examples of hydrophilic polymers used in this invention include polyvinyl alcohol, gelatin, polyethylene oxide, polyvinylpyrrolidone, casein, starch, agar, carrageenan, polyacrylic acid, polymethacrylic acid, polyacryl amide, polymethacrylamide, polystyrene sulfonic acid, cellulose, hydroxyethyl cellulose, carboxymethyl cellulose, hydroxyethyl cellulose, dextran, dextrin, pullulan, and water soluble polyvinyl butyral. These polymers may be employed in combination of more than 2.

In the present invention, one of the features of the ink-jet recording sheet is employing a hydrophilic polymer having a hydroxy group. Preferable hydrophilic polymer having a hydroxy group used for the present invention is a polyvinyl alcohol.

The hydrophilic polymer preferably employed in this invention is polyvinyl alcohol. Polyvinyl alcohols include common polyvinyl alcohol prepared by hydrolyzing polyvinyl acetate, and in addition, modified polyvinyl alcohol such as terminal cation-modified polyvinyl alcohol and anion-modified polyvinyl alcohol having an anionic group.

The average degree of polymerization of polyvinyl alcohol prepared by hydrolyzing vinyl acetate is preferably 1,000 or more, and is more preferably 1,500-5,000. Further, the saponification ratio is preferably 70-100%, and is more preferably 80-99.5%.

Cation-modified polyvinyl alcohols are, for example, polyvinyl alcohols having a primary to a tertiary amino group, or a quaternary ammonium group in the main chain or side chain of the foregoing polyvinyl alcohols as described in JP-A 61-10483, and can be obtained upon saponification of copolymer of ethylenic unsaturated monomers having a cationic group and vinyl acetate.

Listed as ethylenic unsaturated monomers having a cationic group are, for example, trimethyl-(2-acrylamido-2,2-dimethylethyl)ammonium chloride, trimethyl-(3-acrylamido-3,3-dimethylpropyl)ammonium chloride, N-vinylimidazole, N-vinyl-2-methylimidazole, N-(3-dimethylaminopropyl)methacrylamide, hydroxylethyltrimethylammonium chloride, trimethyl-(2-methacrylamidopropyl)ammonium chloride, and N-(1,1-dimethyl-3-dimethylaminopropyl)acrylamide.

The content ratio of monomers containing a cation-modified group of the cation-modified polyvinyl alcohol is 0.1-10 mol % to the vinyl acetate, and is preferably 0.2-5 mol %.

Listed as anion-modified polyvinyl alcohols are, for example, polyvinyl alcohols having an anionic group as described in JP-A 1-206088, copolymers of vinyl alcohols and vinyl compounds having a water solubilizing group as described in JP-A Nos. 61-237681 and 63-307979, and modified polyvinyl alcohols containing a water solubilizing group, as described in JP-A 7-285265.

Further, listed as nonion-modified polyvinyl alcohols are, for example, polyvinyl alcohol derivatives in which a polyalkylene oxide group is added to a part of polyvinyl alcohol as described in JP-A 7-9758, and block copolymers of vinyl compounds having a hydrophobic group and polyvinyl alcohols as described in JP-A 8-25795.

Furthermore, in this invention, polyvinyl alcohol modified with a silyl group is included in polyvinyl alcohol as a modified polyvinyl alcohol, Further, various types of polyvinyl alcohols, in which the degree of polymerization or modification differs, may be employed in a combination of at least two types.

Also, gelatin, polyethylene oxide or polyvinyl pyrrolidone may be employed in combination with polyvinyl alcohol, and these hydrophilic polymers are preferably used in 0-50 weight % to polyvinyl alcohol, and specifically preferably in the range of 0-20 weight %.

The ink-jet recording sheet of the present invention preferably contains a cationic polymer to more effectively prevent image bleeding during storage after recording.

Examples of such cationic polymers include; polyethyleneimines, polyallylamines, polyvinylamines, dicyandiamide-polyalkylenepolyamine condensates, polyalkylenepolyamine-dicyandiamideammonium salt condensates, dicyandiamide-formalin condensates, addition polymers of epichlorohydrin-dialkylamine, polymers of diallyldimethylammonium chloride, copolymers of diallyldimethylammonium chloride-SO₂, polyvinylimidazoles, copolymers of vinylpyrrolidone-vinylimidazole, polyvinylpyridine, polyamidines, chitosan, cationized starch, polymers of vinylbenzyltrimethylammoniumchloride, polymers of (2-methacroiloxyethyl)trimethylammoniumchloride, and polymers of dimethylaminoethylmethacrylate.

Other examples are cationic polymers described in articles of KAGAKU KOGYO JIHO (Chemical Industry Review) dated Aug. 15, 1998, and Aug. 25, 1998, and polymer dye fixing agents described in “KOBUNSHI YAKUZAI NYUMON” (Introduction to High-Molecular Agent), pg. 787, (1992), published by Sanyo Chemical Industries, Ltd.

The average molecular weight of cationic polymers usable in the present invention is preferably in the range of 2,000-500,000 and is more preferably in the range of 3,000-100,000.

The average molecular weight, described herein, refers to the number average molecular weight and also refers to the reduced value of polyethylene glycol obtained by gel permeation chromatography.

Cationic polymers usable in the present invention may be added to a liquid coating composition, and then coated and dried. Alternatively, addition may be carried out in such a manner that their aqueous solution is impregnated into a porous layer after it is coated and dried. Further, listed is a method in which addition is carried out during the period after coating the porous layer and before drying it. Considered as addition methods during the period after coating the porous layer and before drying it are a curtain coating method and a spray coating method.

Further, when cationic polymers usable in the present invention are previously added to a liquid coating composition, they may be uniformly added to the liquid coating composition, and in addition, may be added to it while forming composite particles. Listed as methods to form composite particles employing minute inorganic particles as well as cationic polymers are a method in which cationic polymers are mixed with minute inorganic particles so that minute inorganic particles are adsorbed and covered by the cationic polymers, a method in which the resulting covered particles are coagulated so that higher order composite particles are formed, and a method in which coarse particles prepared by mixing are modified into more uniform composite particles employing a homogenizer.

Cationic polymers usable in the present invention are water-soluble since they generally have a water-solubilizing group. However, they may be water-insoluble due to, for example, compositions of copolymerizable components. It is preferable that they are water-soluble in view of easer production. However, even though they are sparingly water-soluble, it is possible to use them while dissolved in water-compatible organic solvents.

Water-compatible organic solvents, as described herein, refer to organic solvents including alcohols such as methanol, ethanol, isopropanol, or n-propanol, glycols such as ethylene glycol or glycerin, esters such as ethyl acetate or propyl acetate, ketones such as methyl ethyl ketone, and amides such as N,N-dimethylformamide, which are soluble in water in an amount of approximately 10 percent or more. In this case, the used amount of organic solvents is preferably less than or equal to the used amount of water.

Cationic polymers are customarily employed in an amount of 0.1-10 g per m2 of the ink-jet recording sheet, and preferably in an amount of 0.2-5 g.

In the present invention, it is preferable that the ink absorptive layer incorporates boric acid or salts thereof.

Boric acid and salts thereof refer to oxygen acids having a boron atom as the central atom and salts thereof, and specifically listed are orthoboric acid, diboric acid, metaboric acid, tetraboric acid, pentaboric acid, and octaboric acid, and salts thereof.

The used amount of the aforesaid boric acid or salts thereof varies depending on the degree of saponification and degree of polymerization of polyvinyl alcohol, the types of minute inorganic particles, and their ratio to polyvinyl alcohol, the type and amount of cationic polymers, and the pH of liquid coating compositions, but is customarily 20-500 mg per g of polyvinyl alcohol, and is preferably 50-300 mg.

Supports employed for the ink-jet sheet of the present invention will now be described.

Supports of the ink-jet recording sheet of the present invention are not particularly limited, but are preferably non-water absorptive ones. In the case of using water absorptive supports, when compounds comprising zirconium or aluminum atoms form an ink absorptive layer, or during subsequent storage, the aforesaid compounds diffuse into the support whereby it is impossible to exhibit desired effects of the present invention.

Listed as non-water absorptive supports are plastic resinous film supports and supports which are prepared by covering both surfaces of the paper sheet with a plastic resinous film. Listed as plastic resinous film supports are, for example, polyester film, polyvinyl chloride film, polypropylene film, cellulose triacetate film, and polystyrene film, or film supports prepared by laminating these. Plastic resinous films which are transparent or translucent may also be employed.

In the present invention, preferred are non-water absorptive supports which result in no cockling (wrinkling) during printing. Particularly preferred supports are those which are prepared by covering both sides of the paper sheet with plastic resins, and the most preferred supports are those which are prepared by covering both sides of the paper sheet with polyolefin resins.

The most preferable supports in the present invention, which are prepared by covering both sides of the paper sheet with polyolefin resins, will now be described.

Paper employed in the supports is made by employing wood pulp as the main raw material, and alternatively, synthetic pulp such as polypropylene or synthetic fiber such as nylon and polyester. Employed as the wood pulp may be any of LBKP, LBSP, NBKP, NBSP, LDP, NDP, LUKP, and NUKP. However, it is preferable that LBKP, NBSP, LBSP, NDP, and LDP comprising short fiber component in a relatively large amount are employed. Incidentally, the ratio of LBSP and/or LDP is preferably 10-70 weight %.

Preferably employed as the foregoing pulp is chemical pulp (sulfate pulp and sulfite pulp) comprising minimal impurities. Further, also useful is pulp which has been subjected to a bleaching treatment to enhance whiteness.

Suitably incorporated into the paper base may be sizing agents such as higher fatty acids and alkylketene dimers; white pigments such as calcium carbonate, talc, and titanium oxide; paper strength enhancing agents such as starch, polyacrylamide, and polyvinyl alcohol; fluorescent brightening agents; moisture retention agents such as polyethylene glycols; dispersing agents; and softeners such as quaternary ammonium.

The degree of water freeness of pulp employed for paper making is preferably between 200 and 500 ml based on CSF Specification. Further, the sum of the weight % of 24-mesh residue and the weight % of 42-mesh residue regarding the fiber length after beating, specified in JIS-P-8207, is preferably 30-70%. Further, the weight % of 4-mesh residue is preferably not more than 20 weight %.

The basis weight of the paper base is preferably 50-250 g, and is specifically preferably 50-200 g. The thickness of the paper base is preferably 40-250 μm.

During the paper making stage, or alternatively after paper making, the paper base may be subjected to a calendering treatment to achieve excellent smoothness. The density of the paper base is generally 0.7-1.2 g/m³ (JIS-P-8118). Further, the stiffness of the paper base is preferably 20-200 g under the conditions specified in JIS-P-8143.

Surface sizing agents may be applied onto the paper base surface. As surface sizing agents, the foregoing sizing agents capable being added to the paper base may be employed.

The pH of the paper base, when determined employing a hot water extraction method specified in JIS-P-8113, is preferably 5-9.

The polyolefin resin which covers on the paper is described. Listed examples of polyolefin used for the purpose are, polyethylene, polypropylene, and polyisobutylene. Preferred polyolefins are co-polymers containing mainly propylene and polyethylene.

Preferred polyethylenes are further described.

Polyethylene, which covers both surfaces of the paper, is comprised mainly of low density polyethylene (LDPE) or high density polyethylene (HDPE), but it is also possible to employ small amounts of LLDPE and polypropylene.

Specifically, rutile or anatase type titanium oxide is preferably incorporated into the polyethylene layer on the ink absorbing layer side which tend to improve opacity and whiteness. The content ratio of titanium oxide is commonly 1-20 weight % with respect to the polyethylene, and is preferably 2-15 weight %.

In order to control the white background, it is possible to incorporate high heat resistant colored pigments and optical brightening agents into a polyolefin layer.

Listed as colored pigments are, for example, ultramarine blue, iron blue, cobalt blue, phthalocyanine blue, manganese blue, cerulean blue, tungsten blue, molybdenum blue, and anthraquinone blue.

Listed as optical brightening agents are, for example, dialkylaminocoumarin, bisdimethylaminostilbene, bismethylaminostilbene, 4-alkoxy-1,9-naphthalenedicarboxylic acid-N-alkylimide, bisbenzoxazolylethylene, and dialkylstilbene.

The used amount of polyethylene on the front-and back sides of paper is selected so that curling is minimized under low or high humidity after coating of the ink absorptive layer as well as the backing layer. However, the thickness of a polyethylene layer is customarily in the range of 15-50 μm on the ink absorptive layer side, and in the range of 10-40 μm on the backing layer side. It is preferable that the ratio of polyethylene on the front side to the back side is determined to minimize curling, which varies depending on the types and the thickness of the ink absorptive layer, the thickness of the core paper. The ratio of polyethylene of the front to the back is generally 3/1-1/3 in terms of thickness.

The ink-jet recording sheet production method of the present invention will now be described.

In the ink-jet recording sheet of the present invention, other than the ink absorptive layer comprised of each of the constituting elements as described above, various layers such as a backing layer are applied onto a support as required. It is possible to apply such layers onto a support employing any of the several methods which can be suitably selected from the prior art. By employing a preferred method, a liquid coating composition which constitutes each layer is applied onto a support and subsequently dried. In this case, it is possible to simultaneously apply at least two layers. Specifically, simultaneous coating is preferred in which coating of all the hydrophilic binder layers are applied at one time.

Listed as examples of coating methods are; a roll coating method, a rod bar coating method, an air knife coating method, a spray coating method, a curtain coating method, and an extrusion coating method described in U.S. Pat. No. 2,681,294.

In the preparation method of the ink-jet sheet of the present invention, the pH of the coating composition is preferably not more than 5.0, and the surface pH of the ink receiving layer is preferably not more than 4.8.

In order to prepare the ink-jet sheet of the present invention, it is preferable to mix a multivalent metal compound or a mixture of a multivalent metal compound and an amino acid, and moreover a volatile acid (or its salt) using an in-line addition system immediately prior to coating.

By utilizing the in-line addition of each of these additives, it is possible to minimize interaction with other components of the liquid coating composition during standing storage. As a result, it is possible to enhance the stability of the liquid coating compositions as well as to satisfactorily exhibit the target effects of each additive according to the present invention.

An amount of a multivalent metal compound in the ink receptive layer is preferably 0.1-10 g/m², and is more preferably 0.2-5 g/m², and is still more preferably 0.4-1 g/m².

An amount of an amino acid in the ink receptive layer is preferably 0.05-5 g/m², and is more preferably 0.1-2.5 g/m², and is still more preferably 0.3-1 g/m².

A weight ratio of an amino acid to a multivalent metal compound is preferably 0.1:1 to 10:1, is more preferably 0.2:1 to 5:1, is still more preferably 0.3:1 to 2.5:1.

In the present invention, the in-line addition method of each of the aforesaid additives refers to a method in which in a coating apparatus, just prior to applying a liquid coating composition onto a support, for example, to a pipe which is used to supply an ink receptive layer liquid coating composition as a primary liquid coating compositing to a coater, a pipe which is used to convey each of the aforesaid solutions as a secondary liquid coating composition is connected so that they are mixed.

The ink-jet recording sheet of this invention specifically exhibits a large degree of the desired effect in ink-jet recording using water soluble dye ink, but is also usable in ink-jet recording using pigment ink.

In cases when image recording is conducted using the ink-jet recording sheet of this invention, a water based ink recording method is preferably employed.

The foregoing water based ink means a recording liquid solution containing a coloring agent and a solvent, described both below, and other additives. Employed as the coloring agents may be direct dyes, acidic dyes, basic dyes, reactive dyes, water-soluble food dyes, or water-dispersible pigments, which are commonly known in the art of ink-jet printing.

Listed as solvents of the water based ink are water and various water soluble organic solvents, including, for example, alcohols such as methyl alcohol, isopropyl alcohol, butyl alcohol, tert-butyl alcohol, and isobutyl alcohol; amides such as dimethylformamide and dimethylacetamide; ketones or ketone alcohols such as acetone and diacetone alcohol; ethers such as tetrahydrofuran and dioxane; polyalkylene glycols such as polyethylene glycol and polypropylene glycol; polyhydric alcohols such as ethylene glycol, propylene glycol, butylene glycol, triethylene glycol, 1,2,6-hexanetriol, thioglycol, hexylene glycol, diethylene glycol, glycerin, and triethanolamine; and lower alkyl ethers of polyhydric alcohols such as ethylene glycol methyl ether, diethylene glycol methyl (or ethyl) ether, and triethylene glycol monobutyl ether. Of these, preferred are polyhydric alcohols such as diethylene glycol, triethanolamine and glycerin, and lower alkyl ethers of polyhydric alcohols such as triethylene glycol monobutyl ether.

Listed as other water based ink additives are, for example, pH adjusting agents, metal sequestering agents, biocides, viscosity adjusting agents, surface tension controlling agents, wetting agents, surface active agents, and rust inhibiting agents.

In order to improve the wettability of the water based ink to the recording sheet, the water based ink generally exhibits a surface tension in the range of 0.025-0.060 N/m at 20° C., and preferably in the range of 0.03-0.05 N/m. The pH of the foregoing ink is preferably 5-10, and specifically preferably 6-9.

### EXAMPLES

The present invention will be further explained based on examples in the following paragraphs, but it is not limited to these examples. “%” in the examples indicates weight % unless otherwise noted.

### Example 1

<<Preparation of Ink-jet Recording Sheet>>

(Preparation of Silica Dispersions)

(Preparation of Silica Dispersion D-1)

While stirring at 3,000 rpm at room temperature, 400 L of Silica Dispersion B-1 (at a pH of 2.6, containing 0.5% ethanol) comprising 25% vapor phase process silica (Aerosil 300, manufactured by Nippon Aerosil Corp.) at an average particle diameter of the primary particles, uniformly dispersed in advance, of 0.007 μm was added to 110 L of Aqueous Solution C-1 (at a pH of 2.5, containing 2 g of antifoaming agent SN-381, manufactured by San Nopco Ltd.) comprising 12% Cationic Polymer P-1, 10% n-propanol, and 2% ethanol.

Subsequently, while stirring, gradually added to the aforesaid solution was 54 L of Aqueous Mixture Solution A-1 of boric acid and borax at a weight ratio of 1:1 (each at a concentration of 3%).

Thereafter, the resulting mixture was dispersed employing a high pressure homogenizer, manufactured by Sanwa Industry Co., Ltd., at a pressure of 3 kN/cm². The total volume of the resulting dispersion was then adjusted to 630 L by the addition of pure water, whereby nearly transparent Silica Dispersion D-1 was prepared.

(Preparation of Silica Dispersion D-2) While stirring at 3,000 rpm at room temperature, 400 L of aforesaid Silica Dispersion B-1 was added to 120 L of Aqueous Solution C-2 (at a pH of 2.5) comprising 12% Cationic Polymer P-2, 10% n-propanol, and 2% ethanol. Subsequently, while stirring, 52 L of aforesaid Aqueous Mixture Solution A-1 was gradually added. Thereafter, the resulting mixture was dispersed employing a high pressure homogenizer, manufactured by Sanwa Industry Co., Ltd., at a pressure of 3 kN/cm². The total volume of the resulting dispersion was then adjusted to 630 L by the addition of pure water, whereby nearly transparent Silica Dispersion D-2 was prepared.

After preparation, each of aforesaid Silica Dispersions D-1 and D-2 was filtered employing TCP-30 Type Filter, manufactured by Advantech Toyo Co., at a filtration accuracy of 30 μm.

(Preparation of Oil Dispersion)

While heating, 20 kg of diisodecyl phthalate and 20 kg of an antioxidant (AO-1) were dissolved in 45 kg of ethyl acetate. The resulting solution was mixed at 55° C. with 210 L of an aqueous gelatin solution containing 8 kg of acid process gelatin, 2.9 kg of Cationic Polymer P-1, and 5 kg of saponin. After emulsion dispersing the resulting mixture employing a high pressure homogenizer, the total volume was adjusted to 300 L by the addition of pure water, whereby Oil Dispersion was prepared.

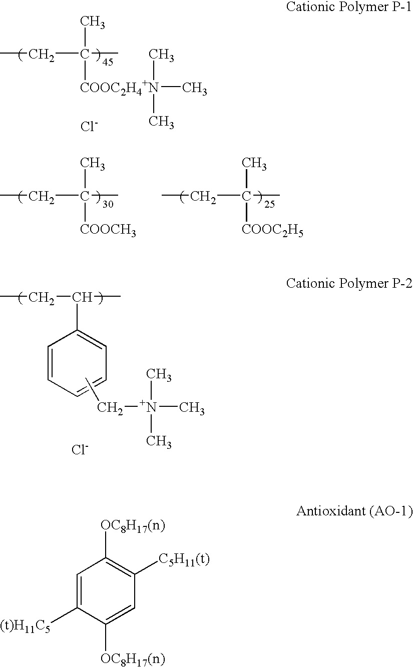

(Preparation of Ink Receptive Layer Liquid Coating Composition)

Each of the additives, described below, was successively mixed with each of the dispersions, prepared as above, whereby each of the porous ink receptive layer liquid coating composition was prepared. Incidentally, the added amount of each additive is represented by the amount per L of the liquid coating composition.

(First Layer Liquid Coating Composition: Lowermost Layer)

| | | |
|---|---|---|
| Silica Dispersion D-1 | 580 | ml |
| 10% aqueous polyvinyl alcohol (PVA203, | 5 | ml |
| manufactured by Kuraray Co., Ltd.) | | |
| solution | | |
| 5% aqueous polyvinyl alcohol (at an | 290 | ml |
| average degree of polymerization | | |
| of 3,800 and a degree of | | |
| saponification of 88%) solution | | |
| Oil Dispersion | 30 | ml |
| Latex dispersion (AE-803, manufactured | 42 | ml |
| by Showa Polymer Co., Ltd.) | | |
| Ethanol | 8.5 | ml |
| Pure water to make | 1000 | ml |

(Second Layer Liquid Coating Composition)

| | | |
|---|---|---|
| Silica Dispersion D-1 | 580 | ml |
| 10% aqueous polyvinyl alcohol (PVA203, | 5 | ml |
| manufactured by Kuraray Co., Ltd.) | | |
| solution | | |
| 5% aqueous polyvinyl alcohol (at an average | 270 | ml |
| degree of polymerization of 3,800 and | | |
| a degree of saponification of 88%) | | |
| solution | | |
| Oil Dispersion | 20 | ml |
| Latex dispersion (AE-803, manufactured | 22 | ml |
| by Showa Polymer Co., Ltd.) | | |
| Ethanol | 8 | ml |
| Pure water to make | 1000 | ml |

(Third Layer Liquid Coating Composition)

| | | |
|---|---|---|
| Silica Dispersion D-2 | 630 | ml |
| 10% aqueous polyvinyl alcohol (PVA203, | 5 | ml |
| manufactured by Kuraray Co., Ltd.) | | |
| solution | | |
| 5% aqueous polyvinyl alcohol (an average | 270 | ml |
| degree of polymerization of 3,800 | | |
| and a degree of saponification of | | |
| 88%) solution | | |
| Oil Dispersion | 10 | ml |
| Latex dispersion (AE-803, manufactured | 5 | ml |
| by Showa Polymer Co., Ltd.) | | |
| Ethanol | 3 | ml |
| Pure water to make | 1000 | ml |

(Fourth Layer Liquid Coating Composition: Uppermost Layer)

| | | |
|---|---|---|
| Silica Dispersion D-2 | 660 | ml |
| 10% aqueous polyvinyl alcohol (PVA203, | 5 | ml |
| manufactured by Kuraray Co., Ltd.) | | |
| solution | | |
| 5% aqueous polyvinyl alcohol (at an average | 250 | ml |
| degree of polymerization of 3,800 | | |
| and a degree of saponification of | | |
| 88%) solution | | |
| 4% aqueous Cation Type Surface Active | 3 | ml |
| Agent-1 solution | | |
| 25% aqueous saponin solution | 2 | ml |
| Ethanol | 3 | ml |
| Pure water to make | 1000 | ml |

Cation Type Surface Active Agent-1

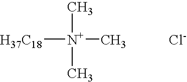

Each of the liquid coating compositions, prepared as above, was filtered employing a TCPD-30 Filter, manufactured by Advantech Toyo Co., at a filtration accuracy of 20 μm and subsequently again filtered employing a TCPD-10 Filter.

(Preparation of Recording Sheets)

(Preparation of Recording Sheet 1)

Four liquid coating compositions at 40° C., prepared as above, were subjected to simultaneous four-layer coating onto a paper support covered by polyethylene on both sides under conditions, employing a slide hopper type coater, to result in the wet layer thickness described below.

<Wet Layer Thickness>

First Layer: 42 μm

Second Layer: 39 μm

Third Layer: 44 μm

Fourth Layer: 38 μm

Incidentally, the aforesaid support had a width of about 1.5 m and a length of about 4,000 m, and was wound into a roll, which was prepared as described below.

The used paper support was prepared as follows. Polyethylene containing 6% anatase type titanium oxide was melt-extruded at a thickness of 35 μm onto the front surface of basic weight 170 g photographic base paper at a water content of 8%, and then 40 μm thick polyethylene was melt-extruded onto the back surface of the same. After applying corona discharge onto the surface, polyvinyl alcohol (PVA235, manufactured by Kuraray Co., Ltd.) was applied to the resulting surface to result in a coated weight of 0.05 g per m² of the recording medium, whereby a sublayer was formed. Subsequently, after applying corona discharge to the back surface, applied was a backing layer comprising about 0.4 g of a styrene-acrylic acid ester based latex binder at a Tg of approximately 80° C., 0.1 g of an antistatic agent (being a cationic polymer), and 0.1 g of about 2 μm silica as a matting agent.

Drying after applying the ink receptive layer liquid coating composition onto the aforesaid support was carried out as follows. The resulting coating was passed through a cooling zone maintained at 5° C. for 15 seconds to lower the temperature of the layer surface to 13° C. and subsequently was dried in a plurality of drying zones by 20-40° C. blown air for 6-7 minutes. Thereafter, it was wound into a roll, whereby comparative Recording Sheet 1 was prepared.

(Preparation of Recording Sheet 2)

Recording Sheet 2 was prepared in the same manner as aforesaid Recording Sheet 1, except that zirconium oxychloride (in Table 1, described as *1) was added in the fourth layer liquid coating composition to result in a coated weight of 0.3 g/m².

(Preparation of Recording Sheet 3)

Recording Sheet 3 was prepared in the same manner as aforesaid Recording Sheet 1, except that zirconium oxychloride was added in the fourth layer liquid coating composition to result in a coated weight of 0.5 g/m².

(Preparation of Recording Sheet 4)

Recording Sheet 4 was prepared in the same manner as aforesaid Recording Sheet 1, except that zirconium oxychloride was added in the fourth layer liquid coating composition to result in a coated weight of 0.5 g/m² and glycine was also added to result in a coated weight of 0.3 g/m².

(Preparation of Recording Sheet 5)

Recording Sheet 5 was prepared in the same manner as aforesaid Recording Sheet 1, except that an aqueous solution containing previously mixed zirconium oxychloride and glycine was added in the fourth layer liquid coating composition to result in a coated weight of zirconium oxychloride and glycine at 0.5 g/m² and 0.3 g/m², respectively.

(Preparation of Recording Sheet 6)

Recording Sheet 6 was prepared in the same manner as aforesaid Recording Sheet 1, except that an aqueous solution containing previously mixed zirconium oxychloride and glycine was added in the fourth layer liquid coating composition to result in a coated weight of zirconium oxychloride and glycine reached 0.5 g/m² and 0.1 g/m², respectively.

(Preparation of Recording Sheet 7)

Recording Sheet 7 was prepared in the same manner as aforesaid Recording Sheet 1, except that an aqueous solution containing previously mixed zirconium oxychloride and glycine was added in the fourth layer liquid coating composition to result in a coated weight of zirconium oxychloride and glycine at 0.5 g/m² and 1.0 g/m², respectively.

(Preparation of Recording Sheet 8)

Recording Sheet 8 was prepared in the same manner as aforesaid Recording Sheet 1, except that an aqueous solution containing previously mixed zirconium oxychloride and glycine was added in the fourth layer liquid coating composition to result in a coated weight of zirconium oxychloride and glycine at 1.0 g/m² and 0.6 g/m², respectively.

(Preparation of Recording Sheet 9)

Recording Sheet 9 was prepared in the same manner as aforesaid Recording Sheet 1, except that zirconium oxychloride was added in the third layer liquid coating composition to result in a coated weight at 0.5 g/m².

(Preparation of Recording Sheet 10)

Recording Sheet 10 was prepared in the same manner as aforesaid Recording Sheet 1, except that an aqueous solution containing previously mixed zirconium oxychloride and glycine was added in the third layer liquid coating composition to result in a coated weight of zirconium oxychloride and glycine at 0.5 g/m² and 0.3 g/m², respectively.

<<Evaluation of Recording Sheets>>

Recording Sheets 1-10, prepared as above, were evaluated on each of the characteristics described below.

(Evaluation of Bleeding Resistance)

About 0.3 mm wide black lines were printed on a solid red image employing an ink-jet printer PM920, manufactured by Seiko Epson Corp. and were stored at 50° C. and 85 percent relative humidity for three days. The line width prior to and after the storage was determined employing a microdensitometer (herein, the width of a portion having 50 percent of the maximum reflection density was determined as the line width). Subsequently, a bleeding ratio (the line width after storage/the line width prior to storage) was obtained, and bleeding resistance was evaluated based on the criteria below.

A: the bleeding ratio was a factor of 1.0-1.2

B: the bleeding ratio was a factor of 1.21-1.50

C: the bleeding ratio was a factor of at least 1.51

(Evaluation of Bronzing Resistance)

Solid black images were printed on each of the recording sheets, employing an ink-jet printer PM920C, manufactured by Seiko Epson Corp. and stored at 23° C. and 80 percent relative humidity for seven days. Thereafter, the state of print images was visually observed and the bronzing resistance was evaluated based on the criteria below.

A: bronzing was barely noted

B: slight bronzing was noted but resulted in no problems

C: local bronzing was noted but resulted in no practical problems

D: obvious bronzing was noted and resulted in practical problems

(Evaluation of Surface Problem Resistance)

Formation of surface problems such as minute gelled material in 0.1 m² of a coated surface was visually observed employing a magnifying glass, and the surface problem resistance was evaluated based on the criteria described below.

A: surface problems were hardly observed

B: minute surface problems of less than 0.5 mm were observed

C: minute surface problems of 0.5-1.0 mm were observed

D: coarse surface problems of at least 1.0 mm were observed

(Evaluation of Gray Balance)

Gray multi-level images were printed on Recording Sheet 1, employing an ink-jet printer PM920C, manufactured by Seiko Epson Corp. At that time, the ejection amount of each ink was controlled so that neutrality became optimal. Under the same conditions, the aforesaid images were printed on Recording Sheets 2-10. Subsequently, deviation of the image tone from the gray image tone of Recording Sheet 1 was visually observed and gray balance was evaluated based on the criteria described below.

A: the gray balance resulted in no visual difference from the gray image tone of Recording Sheet 1

B: the gray balance resulted in slight visual difference from the gray image tone of Recording Sheet 1, but was commercially viable

C: the gray balance resulted in a large difference from the gray image tone of Recording Sheet 1, and was not commercially viable

TABLE 1

| | Multivalent | | | | | | | | | | |
|---|---|---|---|---|---|---|---|---|---|---|---|
| | Metal | | | | | | Individual Evaluation | | | | |
| | Compound | | Amino Acid | | Addition | | Result | | | | |
| Recording | | Added | | Added | Conditions | | | | Surface | | |
| Sheet | | Amount | | Amount | Added | Addition | Bleeding | Bronzing | Problem | Gray | |
| No. | Type | (g/m²) | Type | (g/m²) | Layer | Method | Resistance | Resistance | Resistance | Balance | Remarks |
| 1 | — | — | — | — | — | — | C | A | A | Standard | Comp. |
| 2 | *1 | 0.3 | — | — | Fourth | — | B | C | B | B | Comp. |
| | | | | | Layer | | | | | | |
| 3 | *1 | 0.5 | — | — | Fourth | — | A | D | C | C | Comp. |
| | | | | | Layer | | | | | | |
| 4 | *1 | 0.5 | Glycine | 0.3 | Fourth | Individually | A | B | B | B | Inv. |
| | | | | | Layer | added | | | | | |
| 5 | *1 | 0.5 | Glycine | 0.3 | Fourth | Previously | A | A | A | A | Inv. |
| | | | | | Layer | mixed | | | | | |
| 6 | *1 | 0.5 | Glycine | 0.1 | Fourth | Previously | A | B | B | B | Inv. |
| | | | | | Layer | mixed | | | | | |
| 7 | *1 | 0.5 | Glycine | 1.0 | Fourth | Previously | A | A | A | A | Inv. |
| | | | | | Layer | mixed | | | | | |
| 8 | *1 | 1.0 | Glycine | 0.6 | Fourth | Previously | A | B | B | B | Inv. |
| | | | | | Layer | mixed | | | | | |
| 9 | *1 | 0.5 | — | — | Third | — | A | C | B | C | Comp. |
| | | | | | Layer | | | | | | |
| 10 | *1 | 0.5 | Glycine | 0.3 | Third | Previously | A | A | A | B | Inv. |
| | | | | | Layer | mixed | | | | | |

Comp.; Comparative Example
Inv.; Present Invention
*1: zirconium oxychloride

As can clearly be seen from Table 1, based on comparison of Recording Sheet 1 to Recording Sheets 2 and 3, in order to obtain the desired bleeding resistance, it was useful to use any of the multivalent metal compounds. However, the addition of multivalent metal compounds resulted in degradation of bronzing resistance, surface problem resistance, and gray balance. Based on comparison between Recording Sheets 3 and 4, it was found that the addition of amino acid was effective to minimize degradation due to the addition of the multivalent metal compound. Further, based on comparison between Recording Sheets 4 and 5, it was found that addition of the multivalent metal compound and amino acid, which were previously mixed, was specifically effective.

It is possible to incorporate the multivalent metal compounds as well as the amino acids into an optional ink absorptive layer. However, based on the evaluation results of Recording Sheets 5 and 10, it was found that the addition to the uppermost layer was preferable in view of gray balance.

### Example 2

Recording Sheets 11-19 were prepared in the same manner as Recording Sheet 1 described in Example 1, except that the solution described in Table 1, which was prepared by previously mixing the multivalent metal compound and the amino acid, was added to result in the coated weight described in Table 2.

Each of the codes in Table 2 is detailed below.

*1: zirconium oxychloride

*2: ammonium zirconyl carbonate

*3: zirconyl acetate

*4: basic aluminum chloride

*5: basic sulfuric acid aluminum silicate

*6: magnesium chloride

*7: magnesium sulfate

Recording Sheets 11-19, prepared as above, as well as Recording Sheets 1, 3, and 5, prepared in Example 1, were evaluated in the same manner as Example 1. Table 2 shows the results.

TABLE 2

| | Multivalent | | | | | | | | | | |
|---|---|---|---|---|---|---|---|---|---|---|---|
| | Metal | | | | | | Individual Evaluation | | | | |
| | Compound | | Amino Acid | | Addition | | Result | | | | |
| Recording | | Added | | Added | Conditions | | | | Surface | | |
| Sheet | | Amount | | Amount | Added | Addition | Bleeding | Bronzing | Problem | Gray | |
| No. | Type | (g/m²) | Type | (g/m²) | Layer | Method | Resistance | Resistance | Resistance | Balance | Remarks |
| 1 | — | — | — | — | — | — | C | A | A | Standards | Comp. |
| 3 | *1 | 0.5 | — | — | Fourth | — | A | D | C | C | Comp. |
| | | | | | Layer | | | | | | |
| 5 | *1 | 0.5 | Glycine | 0.3 | Fourth | Previously | A | A | A | A | Inv. |
| | | | | | Layer | mixed | | | | | |
| 11 | *1 | 0.5 | Alanine | 0.3 | Fourth | Previously | A | A | B | A | Inv. |
| | | | | | Layer | mixed | | | | | |
| 12 | *1 | 0.5 | β- | 0.3 | Fourth | Previously | A | B | B | A | Inv. |
| | | | alanine | | Layer | mixed | | | | | |
| 13 | *1 | 0.5 | Phenyl- | 0.3 | Fourth | Previously | A | C | C | A | Inv. |
| | | | alanine | | Layer | mixed | | | | | |
| 14 | *2 | 0.5 | Glycine | 0.3 | Fourth | Previously | A | A | C | A | Inv. |
| | | | | | Layer | mixed | | | | | |
| 15 | *3 | 0.5 | Glycine | 0.3 | Fourth | Previously | A | A | B | B | Inv. |
| | | | | | Layer | mixed | | | | | |
| 16 | *4 | 0.5 | Glycine | 0.3 | Fourth | Previously | A | B | C | A | Inv. |
| | | | | | Layer | mixed | | | | | |
| 17 | *5 | 0.5 | Glycine | 0.3 | Fourth | Previously | B | B | C | A | Inv. |
| | | | | | Layer | mixed | | | | | |
| 18 | *6 | 0.5 | Glycine | 0.3 | Fourth | Previously | B | A | B | A | Inv. |
| | | | | | Layer | mixed | | | | | |
| 19 | *7 | 0.5 | Glycine | 0.3 | Fourth | Previously | B | A | B | A | Inv. |
| | | | | | Layer | mixed | | | | | |

Comp.; Comparative Example
Inv.; Present Invention

As can clearly be seen from Table 2, the results of Recording Sheets 11, 12, and 13 showed that due to the addition of the multivalent metal compound and various types of amino acids, bleeding resistance, bronzing resistance, surface problem resistance, and gray balance were compatible. Further, when comparison was made including the results of Recording Sheet 5 prepared in Example 1, it was found that α-amino acid of a smaller molecular weight as an amino acid resulted in greater improvement effects for bronzing resistance as well as the surface problem resistance.

Still further, based on the results of Recording Sheets 14-19, it was possible to confirm that other than the use of the zirconium compound, the use of an aluminum compound as well as a magnesium compound resulted in almost the same effects. Of these, from the viewpoint of the improvement of bleeding resistance, it was found that the zirconium compound was most effective.

### Example 3

(Preparation of Recording Sheet 20)

Recording Sheet 20 was prepared in the same manner as Recording Sheet 3 described in Example 1, except that an aqueous zirconium oxychloride solution was added via in-line to the fourth layer liquid coating composition to result in a coated weight of 0.5 g/m².

(Preparation of Recording Sheet 21)

Recording Sheet 21 was prepared in the same manner as Recording Sheet 5 described in Example 1, except that an aqueous solution was prepared by previously mixing zirconium oxychloride and glycine to result in a coated weight at 0.5 g/m² and 0.3 g/m², respectively, and the resulting aqueous solution was mixed in as in-line addition to the fourth layer liquid coating composition.

<<Evaluation of Recording Sheets>>

Recording Sheets 20 and 21, prepared as above and Recording Sheets 1, 3, and 5, prepared in Example 1 were evaluated on bleeding resistance, bronzing resistance, and surface problem resistance employing the same methods described in Example 1, and in addition, were evaluated for cracking resistance, viscosity increasing resistance, and coater staining resistance based on the methods described below.

(Evaluation of Cracking Resistance)

The cracking state on the 0.1 m² coated surface of each recording sheet was visually observed employing a magnifying glass and evaluated based in the criteria described below.

A: cracks were hardly observed

B: several minute cracks of less than 0.5 mm were observed

C: several large cracks of at least 0.5 mm were observed

D: large cracks of at least 0.5 mm were observed over the entire surface

(Viscosity Increasing Resistance)

The viscosity of each Fourth Layer Liquid Composition employed to prepare each recording sheet was determined immediately after its preparation and also after being allowed to stand at 40° C. for three hours, employing a falling type viscometer and the viscosity increasing resistance was evaluated based on the criteria described below.

A: the viscosity variation range was less than 15 mPa·s

B: the viscosity variation range was 15-60 mPa·s

C: the viscosity variation range was at least 60 mPa·s

(Evaluation of Coater Staining Resistance)

The liquid coating composition of each recording sheet was allowed to flow for 10 minutes at the same flow rate as the preparation condition for the recording sheet. Thereafter, the degree of staining of the upper portions and of the interior of a slide hopper type coater was visually observed, whereby the coater staining resistance was evaluated based on the criteria below.

A: adhered materials were removed by 40° C. flowing water

B. adhered materials were removed by slight rubbing under 40° C. water flow

C: a strong layer of adhered materials was formed on the surface of the coater and adhered materials were removed only by vigorous rubbing under 40° C. water flow

Table 3 shows the results.

TABLE 3

| | Multivalent | | | | | | | | | | | |
|---|---|---|---|---|---|---|---|---|---|---|---|---|
| | Metal | | | | | | | | | | | |
| | Compound | | Amino Acid | | | Individual Evaluation Result | | | | | | |
| | | Added | | Added | | | | Surface | | Viscosity | Coater | |
| Recording | | Amount | | Amount | | Bleeding | Bronzing | Problem | Cracking | Increasing | Staining | |
| Sheet No. | Type | (g/m²) | Type | (g/m²) | Inline Addition | Resistance | Resistance | Resistance | Resistance | Resistance | Resistance | Remarks |
| 1 | — | — | — | — | Not | C | A | A | A | A | A | Comp. |
| | | | | | used | | | | | | | |
| 3 | *1 | 0.5 | — | — | Not | A | D | C | C | C | C | Comp. |
| | | | | | used | | | | | | | |
| 5 | *1 | 0.5 | Glycine | 0.3 | Not | A | A | A | A | B | B | Inv. |
| | | | | | used | | | | | | | |
| 20 | *1 | 0.5 | — | — | Used | A | C | C | B | B | B | Comp. |
| 21 | *1 | 0.5 | Glycine | 0.3 | Used | A | A | A | A | A | A | Inv. |

Comp.; Comparative Example
Inv.; Present Invention
*1: zirconium oxychloride

As can clearly be seen from Table 3, during preparation of the relevant ink-jet recording sheets, the addition of the multivalent metal compound resulted in problems in which the viscosity of the liquid coating composition varied. As can been seen from comparison between Recording Sheets 3 and 5, the addition of the amino acid minimized the increase in viscosity of the liquid coating composition, but its effect was insufficient. The result obtained from Recording Sheet 21 showed that when the multivalent metal compound and the amino acid were added employing an in-line addition method, the viscosity variation reached a level resulting in almost no problems, the same being true also for coater staining. Consequently, it was found that the in-line addition method was a preferred embodiment of the present invention.

The present invention is capable of providing an ink-jet recording sheet which exhibits excellent ink absorbability and surface glossiness, results in high image density as well as minimal bronzing, and exhibits improved color balance as well as improved bleeding resistance under high humidity, and an ink-jet recording sheet production method which stably produces the same.

### Example 4

<<Preparation of Ink-jet Recording Sheet>>

(Preparation of Recording sheet 101)

Recording sheet 101 was prepared in the same manner as preparing Recording sheet 1 of Example 1.

(Preparation of Recording sheet 102)

Recording sheet 102 was prepared in the same manner as aforesaid Recording sheet 101, except that a zirconium oxychloride based active inorganic polymer (Zircosol ZC-2, manufactured by Daiichi Kigenso Kagaku Kogyo Co., Ltd.) was added to the fourth layer liquid coating composition to result in a coated weight of 0.5 g/m².

(Preparation of Recording sheet 103)

Recording sheet 103 was prepared in the same manner as aforesaid Recording sheet 102, except that the pH of the composition prepared by mixing the first-fourth layer coating compositions was adjusted to 4.5 by employing triethanolamine.

(Preparation of Recording sheet 104)

Recording sheet 104 was prepared in the same manner as aforesaid Recording sheet 103, except that the pH of the composition prepared by mixing the first-fourth layer coating compositions was adjusted to 5.1 by suitably varying the added amount of triethanolamine.

(Preparation of Recording sheet 105)

Recording sheet 105 was prepared in the same manner as aforesaid Recording sheet 102, except that the pH of the composition, prepared by mixing the first-fourth layer coating compositions, was adjusted to 4.5 employing sodium p-toluenesulfonate.

(Preparation of Recording sheet 106) Recording sheet 106 was prepared in the same manner as Recording sheet 105, except that the pH of the composition, prepared by mixing the first-fourth layer coating compositions, was adjusted to 5.1 by suitably varying the added amount of sodium p-toluenesulfonate.

(Preparation of Recording sheet 107)

Recording sheet 107 was prepared in the same manner as aforesaid Recording sheet 102, except that the pH of the composition, prepared by mixing the first-fourth layer coating compositions, was adjusted to 4.5 employing sodium bicarbonate.

(Preparation of Recording sheet 108)

Recording sheet 108 was prepared in the same manner as aforesaid Recording sheet 102, except that the pH of the composition, prepared by mixing the first-fourth layer coating compositions, was adjusted to 4.5 employing sodium carbonate.

(Preparation of Recording sheet 109)

Recording sheet 109 was prepared in the same manner as aforesaid Recording sheet 102, except that the pH of the composition prepared by mixing the first-fourth layer coating compositions was adjusted to 4.5 employing sodium acetate.

(Preparation of Recording sheet 110)

Recording sheet 110 was prepared in the same manner as aforesaid Recording sheet 101, except that an zirconium oxychloride based active inorganic polymer (Zircosol ZC-2, manufactured by Daiichi Kigenso Kagaku Kogyo Co., Ltd.) and glycine were collected to result in a coated weight of 0.5 g/m² and 0.2 g/m², respectively and a sufficiently mixed solution was prepared and added to the fourth layer coating composition after adjusting the pH of the composition prepared by mixing the first-fourth layer coating composition to 4.5 by mixing the specified amount of sodium acetate.

(Preparation of Recording sheet 111)

Recording sheet 111 was prepared in the same manner as Recording sheet 110, except that glycine was replaced with β-alanine in an amount to result in a coated weight of 0.2 g/m².

(Preparation of Recording sheet 112)

Recording sheet 112 was prepared in the same manner as Recording sheet 110, except that glycine was replaced with γ-aminobutyric acid in an amount to result in a coated weight of 0.2 g/m².

<<Evaluation of Recording sheets>>

Recording sheets 101-112 prepared as above were evaluated for each of the characteristics described below.

(Measurement of pH of Layer Surface)

Based on the method described in J. TAPPI Paper and Pulp Test Method No. 49, 50 μl of distilled water was placed on the test layer and an electrode was brought into contact with the wet layer surface for 30 seconds and subsequently, the pH is measured.

(Evaluation of Ink Absorbability)

A solid green image was printed on each of the recording sheets employing an ink-jet printer PM900, manufactured by Seiko Epson Corp. Immediately after printing, the printed portion was finger-rubbed and the resulting image smearing was visually observed. Subsequently, ink absorbability was evaluated based on the criteria described below.

A: even though the print surface was finger-rubbed, image smeared was hardly noticed

B: when the print image surface was finger-rubbed, the image exhibited slight smearing and the fingers were slightly stained

C: when the print image surface was finger-rubbed, the image exhibited obvious smearing and the fingers were stained

Table 4 shows individual evaluation result obtained as above.

TABLE 4

| | pH of | | Individual Evaluation Result | | | | | | |
|---|---|---|---|---|---|---|---|---|---|
| Recording | Liquid | pH of | | | | Surface | Viscosity | Coater | |
| Sheet | Coating | Layer | Ink | Bleeding | Cracking | Problem | Increasing | Staining | |
| No. | Composition | Surface | Absorbability | Resistance | Resistance | Resistance | Resistance | Resistance | Remarks |
| 101 | 4.3 | 4.4 | C | C | A | A | A | A | Comp. |
| 102 | 4.1 | 4.2 | C | A | C | C | B | B | Comp. |
| 103 | 4.5 | 4.5 | B | A | C | C | B | B | Comp. |
| 104 | 5.1 | 5.1 | A | A | D | D | C | C | Comp. |
| 105 | 4.5 | 4.6 | B | A | C | C | B | B | Comp. |
| 106 | 5.1 | 5.2 | A | A | D | D | C | C | Comp. |
| 107 | 4.5 | 5.1 | A | A | C | C | B | B | Comp. |
| 108 | 4.5 | 5.2 | A | A | C | C | B | B | Comp. |
| 109 | 4.5 | 5.2 | A | A | C | C | B | B | Comp. |
| 110 | 4.5 | 5.2 | A | A | B | B | A | A | Inv. |
| 111 | 4.5 | 5.2 | A | A | B | B | A | A | Inv. |
| 112 | 4.5 | 5.2 | A | A | B | B | A | A | Inv. |

Comp.; Comparative Example
Inv.; Present Invention

As can clearly be seen from Table 4, based on the comparison of Recording sheet 101 to Recording sheet 102, in order to result in the sufficient bleeding resistance, it was necessary to incorporate water-soluble multivalent metal compounds. Further, based on the comparison results among Recording sheets 103 vs. 104, and 105 vs. 106, by controlling the layer surface pH at 4.8 or more, it was possible to result in sufficient ink absorbability, while by controlling the pH of liquid coating compositions at 5.0 or less, it was possible to minimize the cracking, the surface problems, the increase in viscosity, and the coater staining. On the other hand, in recording sheets in which volatile acids were not employed, it was not possible to maintain the layer surface pH and the pH of liquid coating compositions within the range which improved these characteristics.

On the other hand, in Recording sheets 107-112 which employed the salts of volatile acids, it was possible to make the pH of the liquid coating compositions lower by at least 0.2 than the layer surface pH. As a result, it was noted that it was possible to realize high ink absorbability and bleeding resistance while minimizing cracking, surface problems, increase in viscosity, and coater staining. Specifically, in Recording sheets 110-112 which were prepared in such a manner that the water-soluble multivalent compound, the amino acid, and the volatile acid were previously mixed and then added to the liquid coating composition resulted in further improvements in each characteristic of cracking, surface problems, increase in viscosity, and coater staining.

In Example 4, during production processing of Recording sheets 101-112, coating and drying were carried out at a relatively low temperature. As a result, zirconium oxychloride based compounds were not allowed to act as a volatile acid containing substance. However, by controlling the temperature, humidity and duration of production, it was possible to allow zirconium oxychloride based active inorganic polymers to function as a volatile acid containing substance.

### Example 5

(Preparation of Recording sheet 117)

Recording sheet 117 was prepared in the same manner as Recording sheet 101 described in Example 4, except that an in-line liquid addition composition was prepared so that the coated amount of zirconyl acetate (Zircosol ZA, manufactured by Daiichi Kigenso Kagaku Kogyo Co., Ltd.) and glycine was 0.5 g/m² and 0.2 g/m², respectively, and the resulting coating composition was added via in-line to the fourth layer liquid coating composition just prior to coating, employing a static mixer.

(Preparation of Recording sheet 120)

Recording sheet 120 was prepared in the same manner as Recording sheet 101 described in Example 4, except that an in-line liquid addition composition was prepared so that the coated amount of a zirconium oxychloride based active inorganic polymer (Zircosol ZC-2, manufactured by Daiichi Kigenso Kagaku Kogyo Co., Ltd.) and glycine was 0.5 g/m² and 0.2 g/m², respectively, and after mixing sodium acetate with the in-line liquid addition composition, the resulting solution was added via in-line to the fourth layer liquid coating composition just prior to coating, employing a static mixer. The amount of sodium acetate added was adjusted to make the mixed liquid composition of the first-fourth layer liquid coating composition and the aforesaid in-line liquid addition composition to reach a pH of 4.5.

(Preparation of Recording sheet 121)

Recording sheet 121 was prepared in the same manner as Recording sheet 120, except that glycine was replaced with β-alanine to result in a coated weight of 0.2 g/m².

(Preparation of Recording sheet 122)

Recording sheet 122 was prepared in the same manner as Recording sheet 120, except that a zirconium oxychloride based active inorganic polymer (Zircosol ZC-2, manufactured by Dai-Ichi Kegenso Kagaku Kogyo Co., Ltd.) was replaced with polyaluminum chloride (Takibine #1500, manufactured by Taki Chemical Co., Ltd.) to result in a coated weight of 0.5 g/m² and glycine was replaced with γ-aminobutyric acid to result in a coated weight of 0.2 g/m².

<<Evaluation of Recording sheets>>

Recording sheets 117, 120, 121, and 122 prepared as above and Recording sheet 101 prepared in Example 4 were evaluated in the same manner as Example 4 for each of: layer surface pH, ink absorbability, bleeding resistance, cracking resistance, surface problem resistance, viscosity increasing resistance, and coater staining resistance. Table 5 shows the results.

TABLE 5

| | pH of | | Individual Evaluation Result | | | | | | |
|---|---|---|---|---|---|---|---|---|---|
| Recording | Liquid | pH of | | | | Surface | Viscosity | Coater | |
| Sheet | Coating | Layer | Ink | Bleeding | Cracking | Problem | Increasing | Staining | |
| No. | Composition | Surface | Absorbability | Resistance | Resistance | Resistance | Resistance | Resistance | Remarks |
| 101 | 4.3 | 4.4 | C | C | A | A | A | A | Comp. |
| 117 | 4.4 | 5.3 | A | A | A | A | A | A | Inv. |
| 120 | 4.5 | 5.2 | A | A | A | A | A | A | Inv. |
| 121 | 4.5 | 5.4 | A | A | A | A | A | A | Inv. |
| 122 | 4.5 | 5.2 | A | A | A | A | A | A | Inv. |

Comp.; Comparative Example
Inv.; Present Invention

As can clearly be seen from Table 5, it was demonstrated the following effects.

Based on the results of Recording sheets 117, 120, 121, and 122, it was noted that by previously mixing the water-soluble multivalent metal compound, the amino acid, and additionally, the volatile acid; and then adding the resulting mixture as an in-line liquid addition composition, and by making the pH of liquid coating composition lower by at least 0.2 than the layer surface pH, it was possible to achieve excellent cracking resistance as well as excellent surface problem resistance and to maintain other characteristics at the desired level.

In Example 5, Recording sheets 101, 113-122 were coated and dried at a relatively low temperature in the same manner as Example 4, wherein the zirconium oxychloride based active inorganic polymer did not function as a volatile acid containing substance. However, by controlling the temperature, humidity, and duration of the production, it was possible to allow the zirconium oxychloride based compounds to function as a volatile acid containing substance.

According to the present invention, it is possible to provide an ink-jet recording sheet which exhibits high ink absorbability, excellent bleeding resistance under high humidity and minimizes quality degradation such as minute surface problems and cracking problems, and can be produced while maintaining stable quality over an extended period of time, as well as an ink-jet recording sheet production method.

What is claimed is:

1. An ink-jet recording sheet comprising a support having thereon an ink absorptive layer containing a multivalent metal compound which is coordinated with an amino acid.

2. The ink-jet recording sheet of claim 1, wherein the ink absorptive layer further contains inorganic microparticles and a hydrophilic polymer and the ink absorptive layer is a porous layer.

3. A method for preparing the ink-jet recording sheet of claim 2, comprising the steps of:
(a) mixing the multivalent metal compound and the amino acid to obtain a first composition;
(b) mixing inorganic microparticles and a hydrophilic polymer to obtain a second composition;
(c) mixing the first composition with the second composition to obtain a coating mixture;
(d) coating the coating mixture on the support to provide the ink absorptive layer; and
(e) drying the ink absorptive layer.

4. The method for preparing the ink-jet recording sheet of claim 3, wherein the mixing of the first composition with the second composition of the step (c) is carried out in an in-line mixing system.

5. The ink-jet recording sheet of claim 1, wherein the multivalent metal compound is selected from the group consisting of zirconium compounds, aluminum compounds and magnesium compounds.

6. The ink-jet recording sheet of claim 5, wherein the multivalent metal compound is a zirconium compound.

7. The ink-jet recording sheet of claim 1, wherein the support is non water absorptive.

8. A method for preparing the ink-jet recording sheet of claim 2, wherein the ink absorptive layer is prepared comprising the steps of:
(a) mixing the multivalent metal compound, the amino acid, inorganic microparticles and a hydrophilic polymer having an hydroxyl group in the molecule to obtain a coating mixture;
(b) coating the coating mixture on the support to provide the ink absorptive layer; and
(c) drying the ink absorptive layer,
wherein a pH value of the coating mixture of the step (a) is smaller than a pH value of a surface of the dried ink absorptive layer by an amount of not less than 0.2.

9. The method according to claim 8, wherein a volatile acid or a salt of the volatile acid is further mixed to the coating mixture of the step (a).

10. The method according to claim 9, wherein the mixing step (a) is carried out in an in-line mixing system by mixing the following two compositions:
(i) a first composition containing the multivalent metal compound, the amino acid, and the volatile acid or the salt of the volatile acid; and
(ii) a second composition containing the inorganic microparticles and the hydrophilic polymer.

11. The ink-jet recording sheet according to claim 1, wherein the amino acid is selected from the group consisting of α-monoamino acids, β-monoamino acids and γ-monoamino acids, each amino acid having carbon atoms of not more than 11 in the molecule.

12. The method according to claim 8, wherein the coating mixture obtained by the step (a) has a pH value of not more than 5.0; and the dried ink absorptive layer has a surface pH value of not less than 4.8.
